(19) United States
(12) Patent Application Publication
(10) Pub. No.: US 2009/0026292 A1
(43) Pub. Date: Jan. 29, 2009

(54) Coatings for use in fuel system components

(75) Inventor: Lucy V. Davies, Peoria, IL (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 11/878,847

(22) Filed: Jul. 27, 2007

(51) Int. Cl. F02M 61/00; B32B 7/02

(52) U.S. Cl. 239/533.2; 239/533.3; 428/217; 428/698

(57) ABSTRACT

A method of controlling wear in a fuel injector assembly is provided. The method can include selecting an injector assembly including a fuel injector plunger including a plunger substrate material and a first coating on the plunger substrate material, and a fuel injector bore including a bore substrate material and a second coating on the bore substrate material. The first and second coatings of the plunger and bore are in sliding engagement and can include chromium nitride. Fuel may be supplied to the bore assembly using a fuel that includes at least one of an ultra-low sulfur fuel and a low lubricity fuel.

### TECHNICAL FIELD

This disclosure relates to fuel system components, and more particularly, to coatings or surface treatments for fuel system components such as fuel injector plungers.

### BACKGROUND

Many internal combustion engines, whether compression ignition or spark ignition engines, use fuel injection systems to provide precise and reliable fuel delivery into the engine combustion chambers. Such precision and reliability are needed to improve fuel efficiency, maximize power output, and reduce undesirable emissions. Generally, fuel injection systems will include a fuel pump and one or more fuel injectors. The fuel pump supplies fuel to the injectors, which subsequently provide precise control of the fuel supply and timing to engine cylinders.

Traditionally, hard coatings can be applied to components of fuel systems to reduce wear and/or prevent corrosion. For example, where opposing parts contact one another, a coating may be used to reduce wear between the components by controlling friction and/or providing increased resistance to wear. However, it is generally believed that it is desirable to apply a coating to only one surface of two opposing parts, while producing another opposing surface from a uncoated metal (e.g., a steel substrate) or other material that is softer than the hard coating. In this way, the uncoated, softer material may be polished by the opposing coating to produce a smooth surface that results in a reduced overall wear rate.

One prior art fuel system component that includes hard coatings on two opposing surfaces is disclosed in U.S. Pat. No. 6,062,499, which issued to Nakamura et. al on May 16, 2000 (hereinafter “the '499 patent”). The '499 patent provides an injector with a conduit bearing surface and a movable core in contact therewith. Both the bearing surface and moveable core are coated with high-hardness materials such as chrome or titanium.

Although the coatings and injector of the '499 patent may provide suitable wear resistance for some applications, the coatings of the '499 patent may have several drawbacks. For example, these coatings may wear at an unacceptably high rate in the presence of newer fuels, such as biodiesels and Toyu fuel. Therefore, these coatings may fail when used under some conditions, thereby causing the fuel system component to leak or lose pressure.

The disclosed coatings aid in overcoming one or more of the aforementioned fuel injector problems and the shortcomings of the related art solutions to such problems.

### SUMMARY OF THE INVENTION

A first aspect of the present disclosure includes a method of controlling wear in a fuel injector assembly. The method includes selecting a fuel injector including a first fuel injector component substrate material; a second fuel injector component substrate material; a first coating on the first substrate material; and a second coating on the second substrate material. The first coating and second coatings are selected from the group consisting of metal nitrides and diamond-like carbon. The method further includes operating the fuel injector assembly such that the first coating material selected from the group consisting of metal nitrides and diamond-like carbon is in sliding engagement with the second coating material selected from the group consisting of metal nitrides and diamond-like carbon. Fuel may be supplied to the injection assembly using a fuel that produces a coefficient of friction between the first coating material and the second coating material that is less than 0.15 in the presence of the selected fuel.

A second aspect of the present disclosure includes a method of controlling wear in a fuel injector assembly. The method can include selecting an injector assembly including a fuel injector plunger including a plunger substrate material and a first coating on the plunger substrate material, and a fuel injector bore including a bore substrate material and a second coating on the bore substrate material. The first and second coatings of the plunger and bore are in sliding engagement and can include chromium nitride. Fuel may be supplied to the injection assembly using a fuel that includes at least one of an ultra-low sulfur fuel and a low lubricity fuel.

A third aspect of the present disclosure includes a method of controlling wear in a machine assembly assembly. The method can include selecting a machine assembly including a including a substrate material and a first coating on the substrate material, and a second substrate material including and a second coating on the second substrate material. The first and second coatings of the first substrate and second substrate are in sliding engagement and can include chromium nitride. Fuel may be supplied to the machine assembly using a fuel that includes at least one of an ultra-low sulfur fuel and a low lubricity fuel.

### BRIEF DESCRIPTION OF THE DRAWINGS

FIG. 1 is a cross-sectional view of a mechanically actuated unit injector, according to one exemplary embodiment.

FIG. 2 is a side view of a coated fuel injector plunger, according to one exemplary embodiment.

FIG. 3 is a side view of a coated fuel injector plunger and bore, according to an exemplary embodiment.

### DETAILED DESCRIPTION

Reference will now be made in detail to the present exemplary embodiments of the invention, examples of which are illustrated in the accompanying drawings. Whenever possible, the same reference numbers will be used throughout the drawings to refer to the same or like parts.

The present disclosure provides fuel system components including improved coatings, as well as methods of producing and using these components to control component wear and prevent fuel system failure. According to one exemplary method of the present disclosure, the coatings can be applied to opposing surfaces of fuel system components, or other machine parts, to provide improved wear resistance during sliding engagement. Further, the coatings and fuel system components of the present disclosure may be selected for use with various fuels, lubricants, or other fluids that may produce unacceptably high corrosion and/or wear with other coatings.

The components of the present disclosure can include any fuel system components or other machine components that are engaged in a sliding configuration in the presence of various liquids. For example, suitable fuel system components can include components of fuel injectors and/or fuel pumps that are in sliding engagement. In one embodiment, such components can include a fuel injector bore and plunger, wherein the bore and plunger are in sliding engagement and include hard coatings on opposing surfaces of the bore and plunger, as described in detail below.

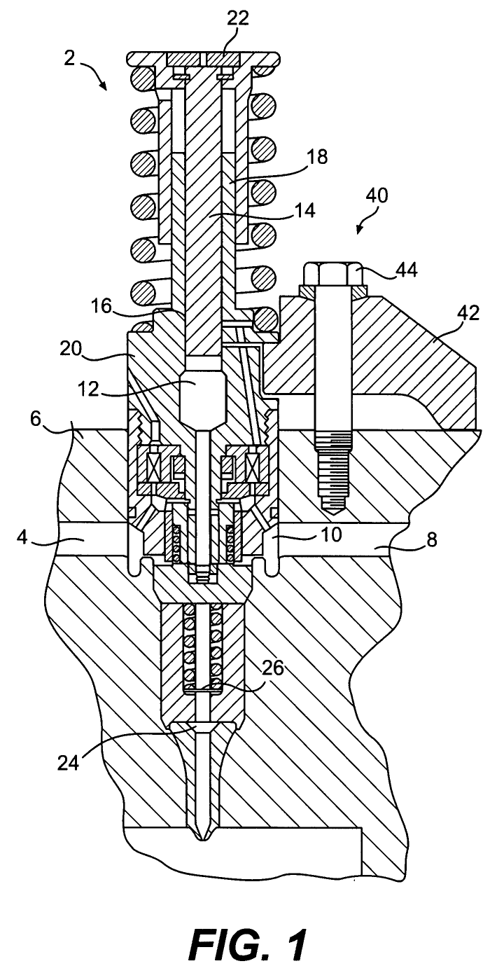

FIG. 1 is a cross-sectional view of a mechanically actuated unit injector, according to one exemplary embodiment. As shown, injector 2 of FIG. 1 can include coating components in sliding engagement. For example, as shown, injector 2 includes a fuel injector plunger 14, which reciprocates within a cylindrical bore 16 to pressurize and inject fuel during machine operation. As described in detail below, opposing surfaces of plunger 14 and bore 16 can include surface coatings configured to provide improved resistance to wear and corrosion. Further, in some embodiments, the coatings may be selected for use with a variety of different fuels and/or other fluids, including biodiesels, Toyu fuel, low lubricity fuels, and/or various lubricants.

As shown, a fuel injector 2 is mounted on an cylinder head 6 via a mounting assembly 40, which includes a clamp 42 attached to injector 2, and a bolt 44 that secures clamp 42 to engine block 6. Fuel is provided to fuel injector 2 via a fuel supply conduit 4 formed in engine block 6, and excess fuel drains from injector 2 via a fuel drain conduit 8. Fuel supply conduit 4 and fuel drain conduit 8 are fluidly-connected by an annular fuel cavity 10 that surrounds the outer periphery of fuel injector 2.

The fuel supplied by fuel supply conduit 4 periodically flows between injection cycles to a generally cylindrical fuel pressurization chamber 12 formed in the center of fuel injector 2. The fuel in the pressurization chamber 12 is periodically pressurized by fuel injector plunger 14 that reciprocates within cylindrical bore 16 formed in a cylindrical extension 18 of a portion of the fuel injector body 20. As plunger 14 is forced downwards by a rocker arm (not shown) attached to a disk 22, the fuel pressure in pressurizing chamber 12 increases, and thus the fuel pressure in a nozzle cavity 24, which is fluidly connected with chamber 12 also increases. When the fuel pressure in nozzle cavity 24 reaches a threshold level, the force exerted by the fluid pressure causes a nozzle check 26 to be forced upwards, thus opening the nozzle and causing fuel to be injected.

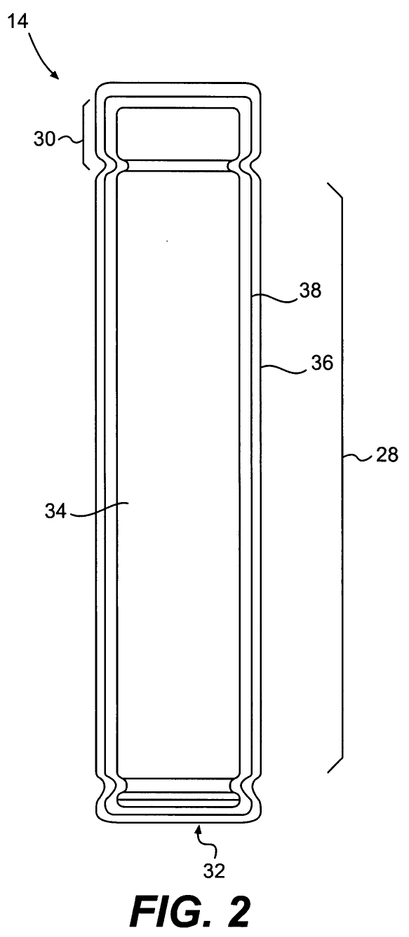

FIG. 2 is a side view of a coated fuel injector plunger 14, according to one exemplary embodiment. As shown, plunger 14 includes a main body section 28, a plunger end section 30, and a loading end section 32. The various sections of the fuel injector plunger are formed or machined from a substrate material 34. Further, plunger 14 can include a primary coating material 36, which can be applied directly to substrate 34, or can be applied to a bonding layer 38 formed on substrate 34, as described in detail below.

Substrate 34 can be produced from a number of suitable materials. For example, in some embodiments, substrate 34 can include any suitable steel, such as a low alloy steel, a tool steel, 51200 steel, and/or any other material. Suitable materials can be selected based on desired physical properties (e.g., resistance to deformation), and/or ability to bond with overlying coatings and to withstand elevated temperatures, as may be present during coating deposition or device use.

In some embodiments, substrate 34 can include a low alloy steel. The term low alloy, as used herein, will be understood to refer to steel grades in which the hardenability elements, such as manganese, chromium, molybdenum and nickel, collectively constitute less than about 3.5% by weight of the total steel composition. Further, low alloy steels may be selected for fuel injector components, including the fuel injector plunger 14 and fuel injector bore 16 due to relatively low cost and high reliability of such steels.

The composition of the primary coating 36 may be selected from various metal nitrides, metal carbides, and carbon-based materials. In some embodiments, coating 36 can include at least one metal nitride selected from chromium nitride, zirconium nitride, molybdenum nitride, titanium-carbon-nitride, or zirconium-carbon-nitride. Alternatively, coating 36 can include a diamond-like carbon (DLC) material such as titanium-containing-DLC, tungsten-DLC, or chromium-DLC.

Prior to coating a selected substrate material, the material may be prepared by cleaning and/or surface treating. For example, cleaning can be accomplished through a number of conventional methods such as degreasing, grit blasting, etching, chemically assisted vibratory techniques, and the like. Further, surface finishing can be performed to enhance coating adhesion and/or to affect coating structure. For example, in some embodiments, the desired substrate surface can be produced by a grinding process to obtain a highly smooth surface, through ultrasonic cleaning with an alkaline solution, and ion-etching of the substrate surface using argon. In addition, in some embodiments, selected substrates may be heat treated prior to coating application to prevent further changes in substrate dimensions after or during coating deposition.

The desired coating can be produced using a number of suitable processes. For example, suitable metal nitride and DLC coatings can be produced using various physical vapor deposition (PVD) and/or chemical vapor deposition (CVD) processes. Further, hybrid processes can be used. The desired coating process can be selected based on a number of factors, including, for example, cost, speed of production, and control of coating composition and structure.

Further, the coating production process may be selected based on the type of substrate material selected for plunger 14 and bore 16. For example, some substrates may be affected by elevated temperatures, and the coating process may be selected to minimize adverse effects of the process on selected substrates, e.g., by limiting the process temperature and/or time. For example, arc vapor or sputtering processes may be selected to produce chromium nitride coatings, and suitable processes may be selected to maintain temperatures below 250° C. or even below 150° C. to prevent dimensional changes in underlying substrates.

Suitable PVD processes can include, for example, arc vapor deposition and sputtering. In general, in arc vapor deposition, an arc source is adapted to impart a positive charge on a generated vapor, and a negative bias voltage is applied to a substrate to deposit on the target substrate. Such arc vapor deposition coating methods, which utilize an arc source to impart a positive charge on a vapor and a negative bias voltage to impart a negative charge on the substrate, are generally known in the art. In sputtering processes, as are known in the art, particles are accelerated at a target material including a material to be deposited on a selected substrate. As the particles strike the target, small amounts of the target are released and deposited uniformly on the substrate.

The coating thickness on plunger 14 should be generally uniform, as measured on a sample of the fuel injector components by scanning electron microscopy, by X-ray fluorescence, or through use of the ball-crater test at a plurality of locations on plunger 14. In one embodiment, primary coating 36 can have a thickness between about 0.5 microns and about 1.7 microns. Primary coating 36 can be applied to the entire length of plunger 14, or the coating may be applied to sections of plunger 14 that may be exposed to higher levels of sliding wear.

In some embodiments, it may be desirable to apply bond layer 38 to provide improved adhesion of the primary coating 36. For example, in some embodiments, a chromium layer or other suitable metal layer may be applied to a low alloy steel substrate to form bond layer 38. If used, the optional bond layer material may be applied using a similar vapor deposition process to yield a bond layer 38 having a thickness of generally between about 0.05 micron and about 0.5 microns; however, a range of suitable thicknesses may be selected based on the specific substrate 34 and coatings 36 used.

Control of some or all of the physical properties of coating layers 36, 38 and coated substrate, other than thickness, are also important to produce a highly-reliable and cost-effective component. For example, coating adhesion, coating hardness, substrate hardness, surface texture, and friction coefficients are some of the physical properties that may be monitored and controlled to produce desirable fuel injector components. Further, different applications may demand different physical properties.

As indicated above, coating 36 should be generally free of surface defects. Further, coating 36 can include specified surface texture ratings or surface texture measurements dependent on the intended use of the component. Surface defects can generally be observed on a sample of fuel injector plungers 14 through the observation of multiple points on the surface of the samples at about one hundred times magnification. The surface observations can be compared to various classification standards to ensure coating 36 is substantially free from surface defects. In addition, coating layers 36, 38 should generally adhere to the selected substrate material. Coating adhesion can be assessed for a given population of fuel injector plungers, for example, by using standard hardness tests (e.g., Rockwell C hardness measurements) in which impact locations on component surfaces are observed and compared to various adhesion classification standards.

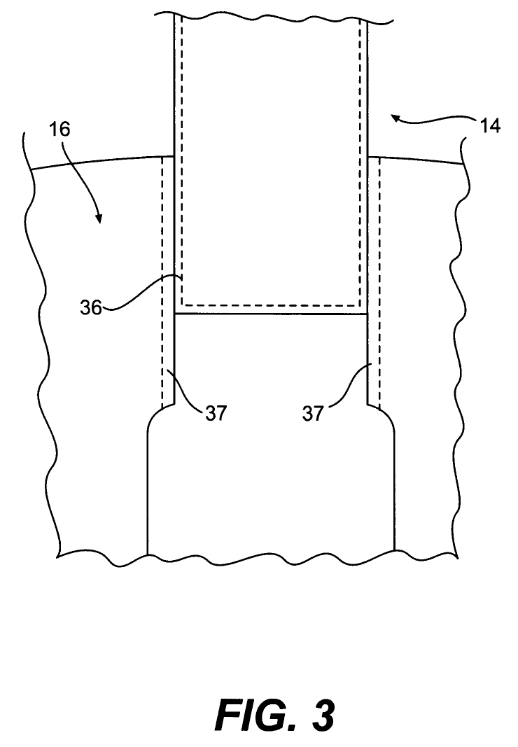

As noted above, it may be desirable to apply coatings to opposing surfaces of machine components. For example, FIG. 3 provides a side view of a coated fuel injector plunger 14 and bore 16, according to an exemplary embodiment. As shown, opposing surfaces of plunger 14 and bore 16 include coatings 36, 37. Further, in some embodiments, coatings 36, 37 may be selected to produce a low wear or low corrosion rate even in the presence of various fuels, including biodiesles, Japanese kerosene, and other fuels and lubricants, as described in detail below.

As noted, coatings 36, 37 can include hard, wear resistant materials. Such materials may be selected to prevent wear of machine components configured to repeatedly engage one another in an impact configuration. For example, suitable primary coating materials can be selected from various metal nitrides and diamond-like carbons (DLC). Further, suitable metal nitrides can include chromium nitride, zirconium nitride, molybdenum nitride, titanium-carbon-nitride, or zirconium-carbon-nitride, and suitable diamond-like carbon materials can include titanium containing diamond-like carbon (DLC), tungsten-DLC, or chromium-DLC. In addition, suitable metal carbon materials, including tungsten-carbide containing carbon may be selected. In addition, either or both of the bore 16 and plunger 14 can include an optional bond layer 38, as described above.

The disclosed coatings can provide good wear resistance when subject to repeated sliding wear, even in the presence of a variety of fuels flowing through fuel injector 2. A variety of suitable fuels may be selected, including various common diesel fuels and newer, low-lubricity or biodiesels. Further, many current machine components have been found to have high wear rates when subject to impact and/or sliding wear in the presence of certain hydrocarbon fuels, such as various low-lubricity fuels and/or low-sulfur fuels. The disclosed coatings have been found to produce sufficient wear resistance when subject to repeated use even in the presence of these fuels. For example, suitable fuels that may be used with the disclosed fuel injector assembly components, as coated with the disclosed coatings, can include ASTM D975 Grade 2D diesel, Toyu fuel, low-sulfur fuel, K1 fuel, and JP8 fuel, as well as other traditional fuels. Further, the disclosed coatings may also be used with fuels containing various additives, including Caterpillar 2564968 fuel additive, methyl soyate (10-30% by volume), rapeseed methyl ester, and reclaimed cooking oil. For example, selected fuel and additive combinations can include Toyu with at least about 10% by volume methyl soyate, or Toyu with at least about 20% by volume methyl soyate. Further, each of the disclosed additives may be combined with the disclosed fuels for use with selected coatings.

In addition, the disclosed coatings and fuel system components may be used with a variety of other fuels. For example, various low lubricity fuels and ultra-low sulfur fuels may produce higher wear rates with some fuel system components. It is believed that the coated fuel system components of the present disclosure will provide low wear rates with many different low lubricity and ultra low sulfur fuels.

Finally, it should be noted that although the disclosed coatings are described for use with plunger 14 and bore 16, the disclosed coatings may be used with any machine components that are subject to repeated impact and/or sliding engagement. Further, such coatings may be used with any machine components subject to these forms of wear, in the presence of various hydrocarbon fuels and/or fuel additives. For example, such components can include any valves or other components used in fuel pumps, fuel injectors, and/or other engine components that may be subject to wear.

### EXAMPLE

### Coatings of Dual Surfaces in the Presence of Alternative Fuels

As noted above, in some embodiments, the disclosed coatings may be applied to two or more components of a fuel injector, fuel pump, or other machine part. For example, in some embodiments, a coating may be applied to a fuel injector plunger and a fuel injector bore. In the past, there has been concern that various fuel injector parts that are subject to wear via friction and/or impact will experience unacceptably high wear rates when used with certain fuel types. Further, there is increasing interest in the use of certain alternative fuels due to rising costs of petroleum products, environmental concerns with emissions from some fuels, and concerns over adequate supplies of petroleum due to decreasing reserves and political confrontations.

Various materials were tested to assess their resistance to wear in the presence of different fuels. The American Society of Testing and Materials (ASTM) D6079 protocol was used. In this protocol, a high-frequency reciprocating rig (HFRR) is used. The HFRR includes a ball that reciprocates against a static flat at 50 Hz using a sliding distance of 1 mm. Each rig was submerged in 2 ml of fuel with a temperature of 60° C. The friction and wear scar diameter for each test were measured. In each test, various material combinations were used. In some tests, only one of the ball or flat was coated with a disclosed coating. In other embodiments, both the ball and flat were coated using PVD with a 52100 steel substrate. Tests were performed using a number of different fuels. For example, Caterpillar 1E0262 fuel, Caterpillar 1E2820 fuel, Caterpillar 1E4008 fuel, Toyu fuel, K1 fuel, and JP8 fuel were used. Further, fuels were tested with various additives, including Caterpillar 2564968 fuel additive, methyl soyate (10-30% by volume), rapeseed methyl ester, and reclaimed cooking oil.

Certain fuels and material combinations were found to produce low coefficients of friction. For example, using CrN coatings on both the ball and flat, a coefficient of friction of less than about 0.15, or less than about 0.13, or less than about 0.12 can be produced using Toyu, Caterpillar 1E0262 fuel, or Toyu with Caterpillar 2564968 fuel additive. It is further believed Caterpillar 1E0262 fuel with or without 20% by volume methyl soyate, Caterpillar 1E2820 fuel with Caterpillar 2564968 fuel additive, Toyu fuel with 20% by volume methyl soyate, Caterpillar 1E4008 fuel with or without Caterpillar 2564968 fuel additive or 20% by volume methyl soyate, K1 fuel, JP8 fuel with or without 20% by volume methyl soyate, reconstitute cooking oil, or methyl soyate alone.

Various materials were tested. For example, coatings on the ball, flat or both using a 52100 steel substrate included sputtered chromium nitride (CrN), tungsten carbide (WC), tungsten diamond-like carbon W-DLC), silicon nitride (SiN), electroless nickel (eNi), amorphous diamond-like carbon (a-DLC), and zirconia (ZrO).

Various materials and fuel combinations produced low wear rates. For example, using a CrN coating on both the ball and flat, wear scars were small using Caterpillar 1E0262 fuel, Toyu fuel, and Toyu fuel with Caterpillar 2564968 additive. Therefore, it is believed that these materials can provide suitable coatings on opposing surfaces of valves for fuel injectors and other machine components with low lubricity fuels.

### INDUSTRIAL APPLICABILITY

The present disclosure provides fuel system components with improved wear resistance and reduced failure rates in the presence of a variety of newer fuels.

The component can comprise a substrate and primary coating deposited on the substrate. The primary coating can include a number of suitable hard materials, such as a metal nitride or diamond-like carbon material. Optionally, a bond layer of chromium or other suitable metal is applied to improve the adhesion properties of the primary coating to the substrate.

In one embodiment, the coated fuel system components can be selected for use with various alternative fuels and other fluids that may cause unacceptably high wear rates when used with uncoated fuel system components. Using the coatings of the present disclosure on opposing surfaces can provide low component wear rates in the presence of convention engine fuels, but also in the presence of alternative fuels, such as low-lubricity fuels, Caterpillar fuels, biodiesels, Toyu fuel, JP8, and K1 fuel. Further, the improved wear can be achieved with the addition of various fuel additives such as methyl soyate, reconstituted cooking oil, and rapeseed methyl ester.

It will be apparent to those skilled in the art that various modifications and variations can be made in the disclosed systems and methods without departing from the scope of the disclosure. Other embodiments of the disclosed systems and methods will be apparent to those skilled in the art from consideration of the specification and practice of the embodiments disclosed herein. It is intended that the specification and examples be considered as exemplary only, with a true scope of the disclosure being indicated by the following claims and their equivalents.

What is claimed is:

1. A method of controlling wear in a fuel injector assembly, comprising:
selecting a fuel injector including:
a first fuel injector component substrate material;
a second fuel injector component substrate material;
a first coating on the first substrate material;
a second coating on the second substrate material, wherein the first coating is selected from the group consisting of metal nitrides and diamond-like carbon and the second coating is selected from the group consisting of metal nitrides and diamond-like carbon;
operating the fuel injector assembly such that the first coating material selected from the group consisting of metal nitrides and diamond-like carbon is in sliding engagement with the second coating material selected from the group consisting of metal nitrides and diamond-like carbon; and
supplying fuel to the bore assembly using a fuel that produces a coefficient of friction between the first coating material and the second coating material that is less than 0.15 in the presence of the selected fuel.

2. The method of claim 1, wherein the fuel includes ultra-low sulfur fuel.

3. The method of claim 1, wherein the fuel includes at least 10% by volume methyl soyate.

4. The method of claim 1, wherein the fuel includes at least 20% by volume methyl soyate.

5. The method of claim 1, wherein the fuel includes Toyu fuel.

6. The method of claim 5, wherein at least one of the first coating and the second coating includes chromium nitride.

7. The method of claim 6, wherein the first coating and the second coating include chromium nitride.

8. The method of claim 1, wherein at least one of the first coating and the second coating is selected from the group consisting of zirconium nitride, molybdenum nitride, titanium-carbon-nitride, zirconium-carbon-nitride, titanium containing diamond-like carbon, chromium containing diamond-like carbon, and tungsten containing diamond-like carbon.

9. The method of claim 1, wherein the fuel is selected from the group consisting of Caterpillar 1E0262 fuel, Caterpillar 1E2820 fuel, Caterpillar 1E4008 fuel, K1 fuel, and JP8 fuel.

10. A method of controlling wear in a fuel injector assembly, comprising:
selecting a fuel injector including:
a fuel injector plunger including a plunger substrate material and a first coating on the plunger substrate material;
a fuel injector bore including a bore substrate material and a second coating on the bore substrate material, wherein the first coating includes chromium nitride and the second coating includes chromium nitride and the first coating and the second coating are in sliding engagement during operation of the fuel injector; and
supplying fuel to the bore assembly using a fuel includes at least one of an ultra-low sulfur fuel and a low lubricity fuel

11. The method of claim 10, wherein the fuel includes ultra-low sulfur fuel.

12. The method of claim 10, wherein the fuel includes at least 10% by volume methyl soyate.

13. The method of claim 10, wherein the fuel includes at least 20% by volume methyl soyate.

14. The method of claim 10, wherein the fuel is selected from the group consisting of Toyu fuel, Caterpillar 1E0262 fuel, Caterpillar 1E2820 fuel, Caterpillar 1E4008 fuel, K1 fuel, and JP8 fuel.

15. A method of controlling wear in a machine assembly, comprising:
selecting a machine component including:
a first substrate material and a first coating on the first substrate material;
a second substrate material and a second coating on the second substrate material, wherein the first coating includes chromium nitride and the second coating includes chromium nitride and the first coating and the second coating are in sliding engagement during operation of the machine assembly; and
supplying fuel to the machine assembly using a fuel includes at least one of an ultra-low sulfur fuel and a low lubricity fuel

16. The method of claim 15, wherein the fuel includes ultra-low sulfur fuel.

17. The method of claim 15, wherein the fuel includes at least 10% by volume methyl soyate.

18. The method of claim 15, wherein the fuel includes at least 20% by volume methyl soyate.

19. The method of claim 15, wherein the fuel is selected from the group consisting of Toyu fuel, Caterpillar 1E0262 fuel, Caterpillar 1E2820 fuel, Caterpillar 1E4008 fuel, K1 fuel, and JP8 fuel.
